(19) United States
(12) Patent Application Publication
(10) Pub. No.: US 2012/0070617 A1
(43) Pub. Date: Mar. 22, 2012

(54) FLOOR COVERING

(75) Inventor: Hubert Dugast, Lentzweiler (LU)

(73) Assignee: Tarkett GDL, Lentzweiler (LU)

(21) Appl. No.: 13/202,898

(22) PCT Filed: Feb. 9, 2010
(86) PCT No.: PCT/EP2010/051590

§ 371 Date: Oct. 13, 2011

Related U.S. Application Data
(60) Provisional application No. 61/172,299, filed on Apr. 24, 2009.

(30) Foreign Application Priority Data
Feb. 23, 2009 (EP) 09002511.5

(51) Int. Cl. E04F 15/16; B28B 11/08; D06N 7/00; B44F 9/02; B44F 9/04

(52) U.S. Cl. 428/151; 428/141; 428/167; 428/156; 428/172; 264/293; 264/138

(57) ABSTRACT

The present invention concerns a synthetic floor covering comprising a decorative pattern representing an element of natural floor covering to be imitated, said floor covering being in the form of a strip, the width of which corresponds to the width of said element of natural floor covering to be imitated, and the length of which corresponds to the length of at least two of said elements of natural floor covering to be imitated, said pattern of at least two natural decoration elements being separated by a pattern imitating a joint connecting said natural decoration elements.

### OBJECT OF THE INVENTION

The present invention relates to a decorative synthetic floor covering having the form of a long strip, and a method of manufacturing same.

### PRIOR ART

Synthetic floor covering, whether made of polyolefins, polyesters, polyamides, or PVC, are well known. In particular, among synthetic floor coverings, the so-called “multilayer” coverings are also well known. Such coverings comprise at least a lower layer, referred to as a support layer, and an upper layer, referred to as a wear layer. Furthermore, these coverings are referred to as decorative as they generally comprise a decorative pattern imitating, for example, the aesthetic appearance of wood flooring, a tiled floor or a stone floor, a decor which is generally printed on one of the faces of the support layer or the wear layer of the floor covering, or even on an additional synthetic layer which is inserted between the support layer and the wear layer.

Generally, these decorative floor coverings are in the form of a roll of great length and great width (FIGS. 1 and 2). Classically, these rolls measure approximately 4 meters wide and from 20 to 40 m long, the decorative pattern of which represents a single piece of natural floor covering that they want to imitate, namely, for example, a complete wood floor, tiled floor or stone floor.

However, packaging in the form of very wide rolls makes them difficult to handle, transport, store and to install on the floor. Thus it has been proposed floor covering of smaller dimensions, and having the shape of a tile, or a slat, easier to transport and to lay.

Traditionally, synthetic decorative floor coverings were proposed in the form of a synthetic element having the dimensions of the element of natural floor covering to be imitated, a floor tile, a wooden slat (FIG. 3) for example, and the decorative pattern or decorative module, of which represents a single and unique natural element to be imitated (a single floor tile or a single wooden slat, a single stone, for example). Also, synthetic decorative coverings were proposed having the shape of a tile of variable dimensions, classically measuring approximately 30 cm by 30 cm, and the decorative pattern of which represents several conjoined natural elements, namely for example a plurality of joined slats of wood to imitate wood flooring (FIG. 4), or a plurality of stone to imitate tiling (FIG. 5).

However, even if the handling of these synthetic elements in the shape of a decorative module, or synthetic decorative tiles, may be easier, it remains that their installation on the floor, in order to reconstitute the entire floor covering, requires a large number of manipulations.

Habitually, the manufacture of a decorative floor covering involves a step of printing the decorative pattern on one of the layers forming the surface covering, printing which is generally performed by rotogravure, a “hollow” printing process by which the ink, which fills the cells of one or more cylinders engraved with the decorative pattern to be printed, is transferred directly to the support to be printed. It is the size and depth of the “cells” of the cylinders that determine the hue of the colour and reproduce the gradation of the image.

Generally, the impression cylinder(s) used has/have a printing width of approximately 4 m, for a diameter between 32 cm and 48 cm, and thus has a spread out surface (perimeter) between 1 m and 1.5 m, which allows a decoration to be printed on a polymeric floor covering having a useful width of approximately 4 meters and of undefined length.

For a floor covering imitating a natural floor covering in its entirety, for example a wood, stone or tiled floor, the impression cylinder is engraved with a decoration comprising a large number of decorative modules representing wooden slats, stones or floor tiles, but also a large number of patterns reproducing the joint that connects these elements together (FIG. 6). This allows a decorative floor covering to be obtained in the form of a roll of long length and large width (FIG. 1), which is then laid in a single piece, possibly being cut so that it adapts to the shape and dimensions of the floor to be covered.

In order to obtain a floor covering in the shape of a tile (FIGS. 4 and 5) comprising a plurality of decorative modules representing, for example, a large number of wooden slats, stones or floor tiles, a floor covering, comprising a pattern representing, in one-piece, the natural floor covering to be imitated, is produced then cut in a random method by a static press to obtain tiles of the desired dimensions.

Generally, to obtain decorative modules having the dimension and representing a unique element of natural floor covering to be imitated (FIG. 3), namely a unique wooden slat, a unique stone, or a unique floor tile, a so-called “all over” floor covering, i.e. comprising a natural pattern without joint patterns, is produced, then cut by a static press to obtain decorative modules of dimensions that are identical, or equivalent, to the wooden slats, stones or tiles, that they want to imitate.

### PURPOSE OF THE INVENTION

The present invention proposes a solution that does not present the drawbacks of the prior art.

It aims to provide an element of decorative floor covering for which the handling, transport, storage and installation are facilitated.

Furthermore, it aims to provide a printing and manufacturing method of a decorative floor covering that does not have the drawbacks of the prior art.

It aims to provide a method for manufacturing an easy-to-install decorative floor covering.

### SUMMARY OF THE INVENTION

The present invention describes a synthetic floor covering comprising a decorative pattern representing an element of natural floor covering to be imitated, said floor covering being in the form of a strip, the width of which corresponds to the width of said element of natural floor covering to be imitated, and the length of which corresponds to the length of at least two of said elements of natural floor covering to be imitated, said pattern of at least two natural decoration elements being separated by a pattern imitating a joint connecting said natural decoration elements.

According to special embodiments, the floor covering comprises one or any combination of several of the following characteristics:
the strip is between 10 and 50 cm in width and said strip is between 4 m and 30 m in length,
the decorative pattern imitates a wooden slat,
the decorative pattern imitates a stone or floor tile,
the synthetic material used for said covering is polyolefin, and/or PVC based,
the floor covering is a multilayer covering, comprising a support layer and a wear layer,
the floor covering also includes an adhesive composition applied on the face of said covering which will enter into contact with the surface to be covered,
the strip of floor covering is packed in the form of a roll.

The present invention also describes a method for printing a synthetic support comprising the step of taking a synthetic support and printing on said support, a decorative pattern representing the pattern of an element of natural floor covering to be imitated, and a pattern imitating a joint connecting the elements of said natural floor covering to be imitated, the printing being performed using an impression cylinder engraved with at least one pattern imitating a joint connecting the elements of said natural floor covering to be imitated, said engraved pattern extending either over the entire periphery of said cylinder, or over the entire width of said cylinder, and said engraved pattern being regularly spaced from another pattern engraved on said cylinder (2) by a distance corresponding to the length of said element of natural floor covering to be imitated.

According to particular embodiment of the printing method according to the invention, the synthetic support is the wear layer and/or the support layer of a multilayer floor covering.

The present invention also describes a method for manufacturing a synthetic floor covering comprising the steps of printing a synthetic support according to the printing method of the invention to form a printed support, forming a floor covering decorated using said printed support, either by calendaring said printed support with a wear layer and a support layer of a multilayer floor covering, or by calendaring said printed support with a wear layer of a multilayer floor covering, and cutting said decorated floor covering perpendicularly to the pattern imitating the joint, forming strips of a width corresponding to the width of the element of natural floor covering to be imitated.

According to special embodiments, the method for manufacturing the synthetic floor covering according to the invention comprises one or any combination of several of the following characteristics:
the method also includes a step of applying an adhesive composition to the face of the floor covering that will enter into contact with the surface to be covered,
the method also includes a step of packaging strips of synthetic floor covering in the form of a roll.

### BRIEF DESCRIPTION OF FIGURES

FIG. 1 is a schematic representation of a synthetic floor covering, according to the prior art, imitating wood flooring.

FIG. 2 is a schematic representation of a synthetic floor covering, according to the prior art, imitating floor tiling.

FIG. 3 is a schematic representation of a synthetic floor covering, according to the prior art, said covering consisting of a decorative module imitating a wooden slat.

FIG. 4 is a schematic representation of a synthetic floor covering according to the prior art, said covering having the form of a tile and imitating wood flooring.

FIG. 5 is a schematic representation of a synthetic floor covering, according to the prior art, said covering having the form of a tile and imitating floor tiling.

FIG. 6 schematically represents an impression cylinder according to the prior art, used to print a decorative floor covering, represented in FIG. 1, and imitating, in a single piece, the natural floor covering to be imitated.

FIG. 7 schematically represents the floor covering according to the invention, comprising four decorative modules imitating a wooden slat, separated by a pattern reproducing a joint.

FIG. 8 schematically represents a first form of embodiment of the printing process of the floor covering according to the invention.

FIG. 9 schematically represents a second form of embodiment of the printing process of the floor covering according to the invention.

FIG. 10 is a schematic representation of the intermediate covering cut to form the floor covering according to the invention.

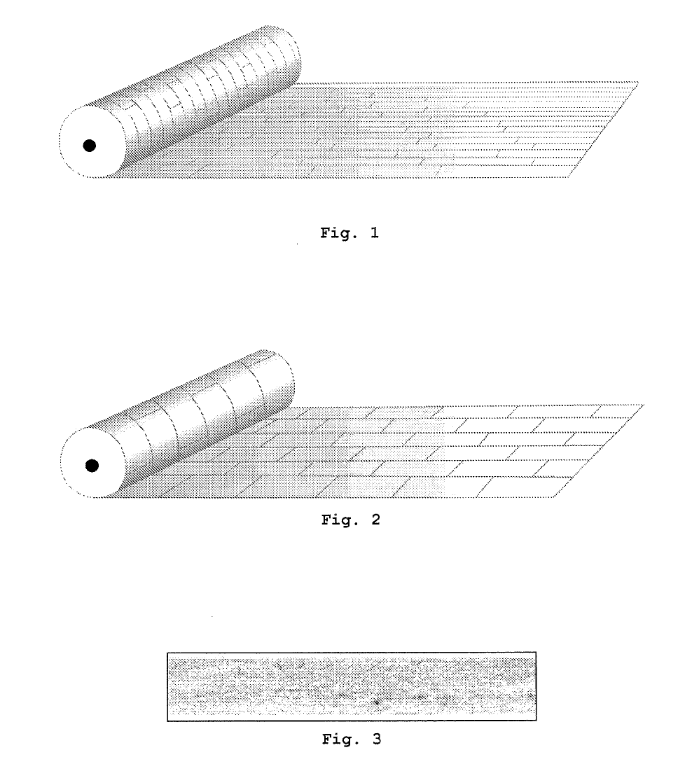

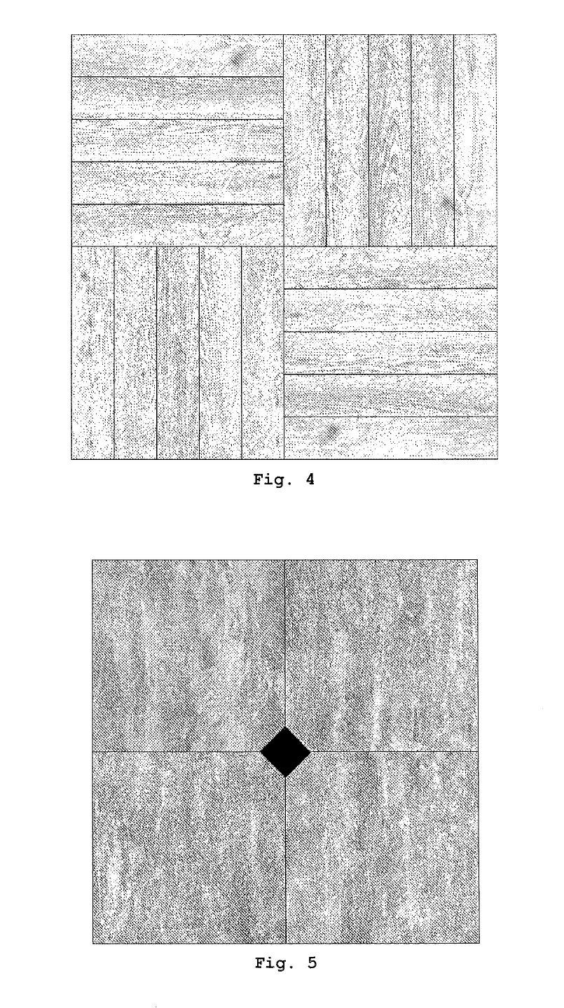

### DETAILED DESCRIPTION OF THE INVENTION

The decorative floor covering according to the invention is in the form of a strip 8 of synthetic floor covering, longer than it is wide, which includes a decorative pattern that imitates elements of natural floor covering joined together one after the other.

Considering that a decorative module 9 reproduces, in terms of aesthetics and dimensions, an element of natural floor covering (wooden slat, a stone, a floor tile, for example), the synthetic floor covering according to the invention comprises at least two decorative modules 9, one after the other, separated by a pattern 6 reproducing the joint connecting the elements of natural floor covering to be imitated. However, the floor covering according to the invention can include as many decorative modules 9 as necessary; two, three, a dozen, or fifteen for example. It can include a number n of decorative modules, n being greater than or equal to 2.

Thus, the width of the floor covering according to the invention corresponds to the width of the element of natural floor covering to be imitated, namely to the width of a wooden slat, a stone or a floor tile for example, and corresponds to the width of the decorative module 9.

The width is chosen according to the element of natural floor covering to be imitated. Nevertheless, it is the same along the length of the strip of floor covering according to the invention. Preferably, for a synthetic floor covering imitating wooden slats, its width is between 10 and 30 cm, preferably between 10 and 20 cm, advantageously it is 20 cm. For a synthetic floor covering imitating stones or floor tiles, its width is between 10 and 50 cm, preferably between 25 cm.

The length of the synthetic floor covering according to the invention corresponds to the length of at least two elements of joined natural floor covering to be reproduced, namely, for example, the length of two slats of wood, two stones or two floor tiles, placed end to end, increased by the thickness of the joint. This length thus corresponds to the length of at least two decorative modules 9 separated by a pattern 6 reproducing a joint.

The length of the decorative modules 9 is a function of the elements of natural floor covering to be imitated. Their length is modulated by the frequency of the appearance of the pattern 6, imitating the joint, in the natural pattern 5 of the floor covering according to the invention. For example, for floor covering imitating a wooden slat, the pattern imitating the joint 6 can be repeated in the natural wood pattern 5 every 33 cm to 200 cm.

The length of the floor covering according to the invention is a function of the type of natural floor covering elements to be imitated and the number of joined natural elements to be reproduced; it is thus variable. The length can be undefined, although, for practical transportation and installation reasons, and to take into account the dimensions of the surface areas traditionally to be covered, a floor covering according to the invention, for residential use and which imitates slats of wood for wood flooring, shall preferably have a length between 4 m and 30 m. A residential floor covering, imitating stones or floor tiling, shall preferably have a length between 4 m and 30 m, preferably 40 and 15 cm.

The synthetic floor covering according to the invention presents the advantage of being easily transportable, manipulated and storable, and has an easier handling and laying to the ground. Also unlike a rigid decorative element, such as for example a strip of wood, its flexibility allows to smooth out the potential irregularities of the floor to cover.

The synthetic floor covering according to the invention comprises a decorative pattern 5 of the same type along the entire length of the strip 8, a pattern 5 that can be identical or different in terms of appearance, tint or colour. For example, in a synthetic floor covering according to the invention imitating slats of wood (FIG. 7), the decorative wood pattern 5 can have a colour, tint, and graining identical the entire length of the strip 8 of floor covering. Nevertheless, the graining reproduced can also be different from one decorative module 9 to another.

In another embodiment of the invention, one or both ends of the floor covering can comprise a decorative module 9 of a length that is different from the other decorative modules 9 that make up the floor covering, for example, a length that corresponds to a half-length of the other modules. Thus, when laying the floor covering according to the invention, the decorative modules 9 of a strip 8 of covering are shifted in relation to the decorative modules of the adjacent strip, thereby giving the surface covered the appearance of true wood flooring.

The decorative pattern 5 reproduces the aesthetic appearance of all element of natural floor covering, whether it be for example, a strip of wood, a strip of bamboo, a marble floor tile, tiling, terra cotta, stone, granite, slate, pebbles or mosaics. Thus, the decorative modules 9 of the floor covering according to the invention reproduce the aesthetic appearance, but also the dimensions of all elements of natural floor covering.

The pattern 6 reproducing the joint separating the decorative modules 9 of the floor covering according to the invention can reproduce the dimensions and the aesthetic appearance of all joints connecting the natural elements to be imitated. The joint pattern 6 can be more or less thick or pronounced, and thus more or less discrete. The pattern 6 can be a more or less thick line, more or less pronounced, or can be the demarcation between different structures or colours of the decorative pattern 5.

The floor covering according to the invention can by all appropriate synthetic floor covering, preferably, it is a flexible floor covering. It may be a thermoplastic resin-based floor covering such as, for example, PVC (Polyvinyl chloride), polyesters, polyolefins or even acrylics, vulcanised resins such as SBS (Styrene butadiene Styrene) or cross-linked such as SBR (Styrene Butadiene Rubber). Preferably, it is a PVC-based multilayer covering.

In particular, in the family of PVC-based coverings, it may be homogenous or heterogeneous floor coverings. Preferably, it concerns products listed according to European standard EN 651, polyvinyl chloride-based floor coverings according to standard EN 653, expanded polyvinyl chloride-based floor coverings according to standard EN 649. Advantageously, it may concern floor coverings described in patent applications EP 1276621 and EP 1639193, or in patents EP 1360366 and EP 1507920.

In the family of polyolefin-based floor coverings, it may concern coverings such as those described in patent EP 1567336.

In another embodiment of the invention, the floor covering according to the invention is self-adhesive. On the face entering into contact with the surface to be covered, it thus comprises all appropriate means to secure the floor covering, for example, Velcro® type means, glue, or other adhesive composition, either permanent or temporary. In the case of a glue or adhesive composition, the floor covering thus also comprises a protective sheet on its adhesive surface.

The floor covering according to the invention can possibly be chamfered along its entire length and/or its entire width.

The floor covering according to the invention can be packaged in all appropriate formats. Preferably, it is packaged in the form of rolls.

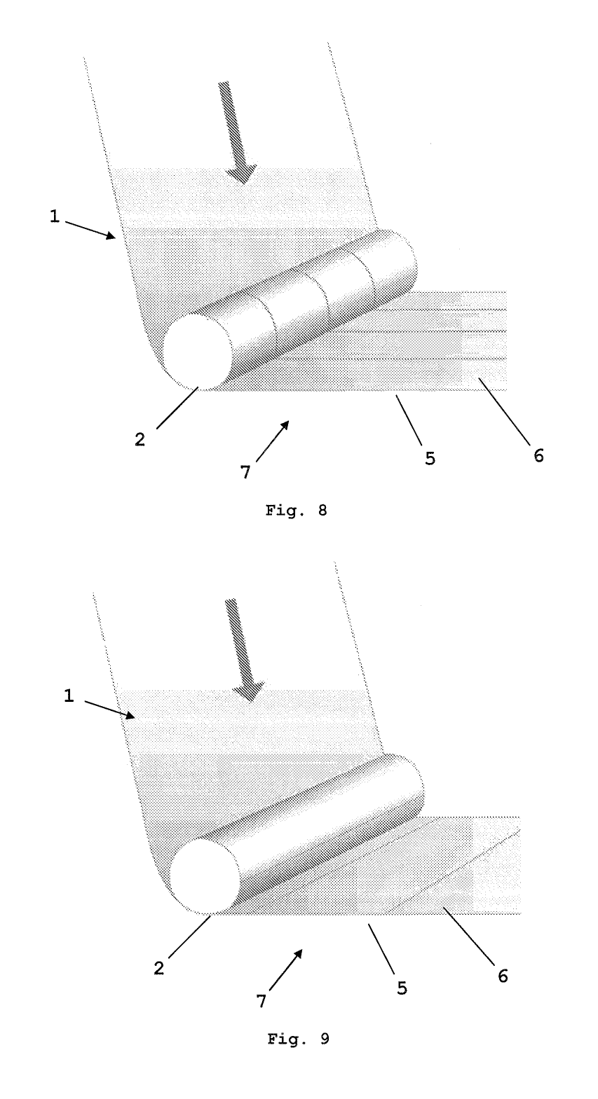

The decorative floor covering according to the invention is, preferably, produced from a printed support 7 (FIG. 8 or FIG. 9) which is not intended to be used as floor covering but which is an intermediate product allowing to make the decorative floor covering according to the invention.

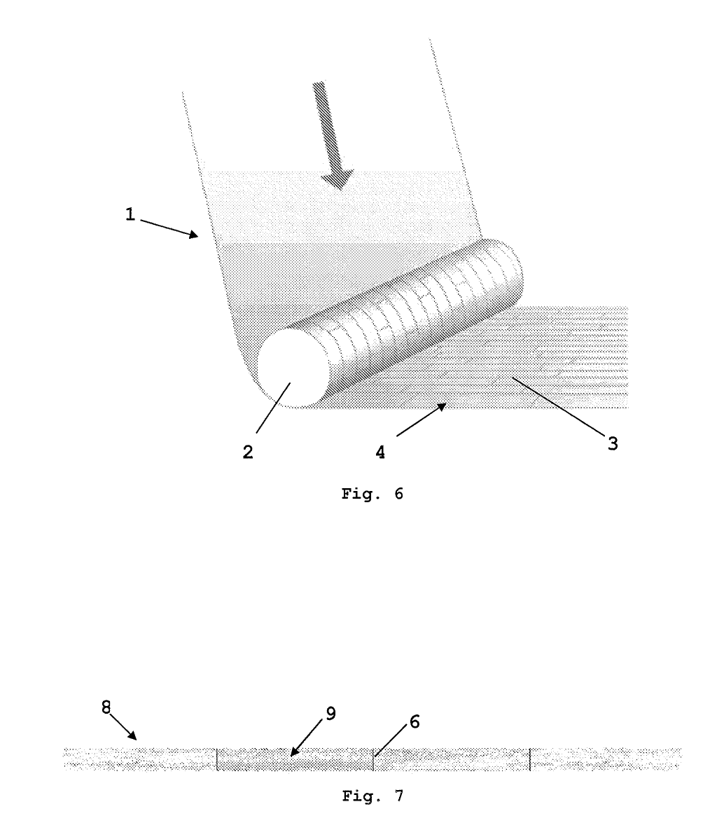

Contrary to a decorative covering according to the prior art (FIG. 6), which comprises a decorative pattern 3 having a multitude of decorative modules 4 separated by a multitude of joint patterns forming a grid, or contrary to a so-called “all over” covering, including a natural pattern without joint pattern, the printed support 7 includes a natural pattern 5 and a joint pattern 6 which extends, in a first embodiment, along the entire length of the printed support 7 (FIG. 8) or, in a second embodiment, along the entire width of the printed support 7 (FIG. 9). Both embodiments depend on the method for printing the decoration and thus on the direction the pattern 6 is printed. Nevertheless, regardless of the direction in which the joint pattern 6 is printed, the pattern 6 is repeated several times on the printed support 7, in a regularly spaced manner. The space between each joint pattern 6 corresponds to the length of the element of natural floor covering to be reproduced. For example, for a natural pattern 5 imitating a wooden slat, the joint pattern 6 is repeated every 33 cm to 2 meters.

For a natural pattern 5 having an intrinsic orientation, for example for a natural wood pattern 5, the orientation of which is given by the grain of the wood, the joint pattern 6 is printed perpendicularly to the orientation of the natural pattern.

The printing of the natural pattern 5 and the pattern imitating the joint 6 is performed by all suitable means, preferably by rotogravure. Thus, the joint pattern 6 is printed on the synthetic support 1 by means of one or several impression cylinders 2, either only parallel to the axis of the impression cylinder(s) 2 (FIG. 9), particularly if the orientation of the natural pattern 5 to be printed corresponds to the direction of rotation of the cylinder 2, or only perpendicular to the axis of the cylinder(s) 2 (FIG. 8), particularly if the orientation of the natural pattern 5 to be printed corresponds to the axis of rotation of the impression cylinder 2.

The impression cylinder(s) 2 are all suitable impression cylinders. Such cylinders have characteristics identical or equivalent, notably in terms of dimensions, constituent materials, to those of an impression cylinder traditionally used in a rotogravure or screen printing process, except for the pattern imitating the joint which is engraved, by all suitable means, one or more times perpendicularly, or in another embodiment, parallel to its axis (FIGS. 8 and 9, respectively). Preferably, the impression cylinder 2, comprising the joint patterns, is a cylinder that also prints the last structure, or colour, of the decorative pattern 5.

In another embodiment of the impression cylinder 2 (FIG. 8), the pattern imitating the joint is engraved three times on the periphery of a cylinder 2 having a spread out surface of approximately 1 m, the joint pattern being separated a distance corresponding to the length of the natural decorative element to be imitated, for example by a length of approximately 33 cm in order to obtain a printed support 7 imitating strips of wood.

In another embodiment of the impression cylinder 2 (FIG. 9), the pattern imitating the joint is engraved once along the axis of a cylinder 2 having a spread out surface of approximately 1 m, in order to obtain a decorated support 7 comprising joint patterns 6 repeated approximately every meter.

The printing ink is all suitable ink, adapted to the natural pattern 5 and the joint pattern 6 to be printed.

The natural pattern 5 and the joint pattern 6 are printed on any synthetic support 1. It may concern a synthetic film or a wear layer and/or the support layer of a multilayer floor covering which, once decorated, forms an integral part of a floor covering, for example by insertion between the wear layer and the support layer of the multilayer product. It may concern a PVC-based synthetic single-layer support, or a synthetic support comprising several synthetic layers, as described for example in patent EP 1567336.

In the embodiment in which the synthetic support 1 to be printed is the support layer of a multilayer surface covering, the printing performed continuously on a layer of pregelified plastisol. The ink is dried, a wear layer in the form of a transparent plastisol layer is added, and then the assembly is placed in an oven. Subsequent mechanical graining operations of the wear layer are possible after exiting the oven, while the application of a wear layer of a protective varnish, for example a polyurethane-based varnish, for enhanced resistance to traffic. Furthermore, the subsequent operations can also be those described in the European patent application EP 1639193.

In the embodiment in which the support to be printed 1 is a synthetic single-layer support, once printed, it is hot glued by calendaring on the support layer of the multilayer floor covering. Nevertheless, the assembly can also be accomplished using a double-belt assembly device of Auma or Thermofix type for example, which are devices used to heat the polymer comprising the decorative layer or the support layer until it becomes soft, while maintaining adequate pressure, allowing the various synthetic layers to adhere to each other without the use of glue.

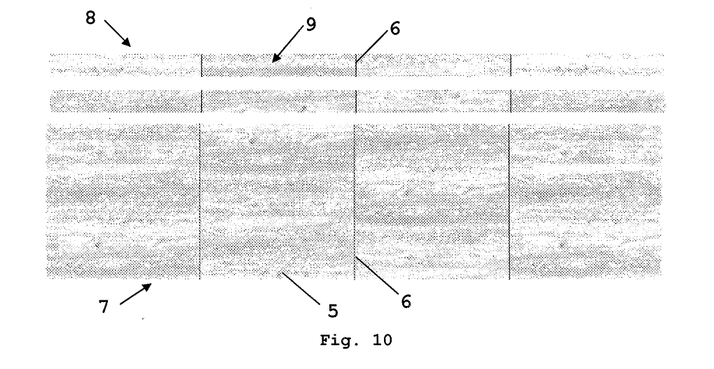

The decorated floor covering obtained is then cut, using appropriate means, using circular knives for example, into lengths or strips having a width corresponding to the width of the element of natural floor covering to be imitated (FIG. 10), in order to obtain the floor covering according to the invention in the form of a strip 8 (FIG. 7). Preferably, the cut is made in the solid material, on the decorated covering obtained, then the covering according to the invention is packaged in the form of a roll of large dimensions.

Possibly, the decorated covering in the form of a roll of large dimensions before being cut, or the floor covering in the form of strips 8, can also be subjected to mechanical graining by any appropriate means.

For a self-adhesive floor covering, an adhesive composition can be applied, by all suitable means, to the surface of the support layer of the decorated floor covering before it is cut, or of the decorated floor covering in strip form 8, which will enter into contact with the surface to be covered. In addition, the decorated floor covering and adhesive comprises a sheet that protects adhesive composition.

The floor covering according to the invention, self-adhesive or otherwise, can be packaged in all suitable formats, preferably in the form of a roll.

The method for manufacturing the floor covering according to the invention has the advantage of not requiring equipment that is new or different from that already used to produce and/or print synthetic floor coverings.

The implementation, particularly the installation, of the synthetic floor covering according to the invention is very easy. The strip 8 of floor covering is simply laid starting from the corner of the room whose surface must be covered, which has been cleaned and prepared as required, possibly by unrolling the floor covering if it was packaged in the form of a roll, while removing the sheet protecting the adhesive as the floor covering is put into place, in the case of an adhesive covering. Then, simply lay a new strip 8 of floor covering adjacent to the first strip and repeat the operation until the entire surface of the floor is covered. Advantageously, the strips 8 of covering are laid so that the decorative modules 9 of a strip 8 are shifted in relation to the decorative modules 9 of the adjacent strip 8.

### Key:

1. synthetic support,
2. impression cylinder,
3. decorative pattern of a floor covering according to the prior art,
4. decorative modules of a floor covering according to the prior art,
5. decorative pattern representing an element of natural floor covering to be imitated,
6. pattern imitating a joint connecting natural decoration elements,
7. printed synthetic support,
8. strip of floor covering,
9. decorative module of the floor covering according to the invention.

1. A synthetic floor covering comprising a decorative pattern (5) representing an element of natural floor covering to be imitated, said floor covering being in the form of a strip (8), the width of which corresponds to the width of said element of natural floor covering to be imitated, and the length of which corresponds to the length of at least two of said natural floor covering to be imitated elements, said pattern (5) of at least two natural decoration elements being separated by a pattern imitating a joint connecting said natural decoration elements.

2. The synthetic floor covering according to claim 1, in which the width of the strip (8) is between 10 and 50 cm and the length of said strip (8) is between 4 m and 30 m.

3. The synthetic floor covering according to claim 1, in which the decorative pattern (5) imitates a wooden slat.

4. The synthetic floor covering according to claim 1, in which the decorative pattern (5) imitates a stone or a floor tiling.

5. The synthetic floor covering according to claim 1, in which the synthetic material used for said covering is polyolefin, and/or PVC-based.

6. The synthetic floor covering according to claim 1, said floor covering being a multilayer covering comprising a support layer and a wear layer.

7. The synthetic floor covering according to claim 1, also comprising an adhesive composition applied on the face of said covering which will enter into contact with the surface to be covered.

8. The synthetic floor covering according to claim 1, in which the strip of floor covering is packaged in the form of a roll.

9. A method for printing a synthetic support (1), said method comprising the steps of:
taking a synthetic support (1),
printing on said support (1), a decorative pattern (5) representing the pattern of an element of natural floor covering to be imitated, and a pattern (6) imitating a joint connecting the elements of said natural floor covering to be imitated, the printing being performed using an impression cylinder (2) engraved with at least one pattern (6) imitating a joint connecting the elements of said natural floor covering to be imitated, said engraved pattern extending either over the entire periphery of said cylinder (2), or over the entire width of said cylinder (2), and said engraved pattern being regularly spaced from another pattern engraved on said cylinder (2) by a distance corresponding to the length of said element of natural floor covering to be imitated.

10. The printing method according to claim 2, in which the synthetic support (1) is a wear layer and/or the support layer of a multilayer floor covering.

11. The method for manufacturing a synthetic floor covering according to claim 1, said method comprising the steps of:
printing a synthetic support (1) according to the method of claim 9, to form a printed synthetic support (7),
forming a decorated floor covering using said printed support (7), either by calendaring said printed support (7) with a wear layer and a support layer of a multilayer floor covering, or by calendaring said printed support (7) with a wear layer of a multilayer floor covering,
cutting out said floor covering decorated perpendicularly with the pattern (6) imitating the joint, to form strips (8) of a width corresponding to the width of the element of natural floor covering to be imitated.

12. The method according to claim 11, comprising a step of applying an adhesive composition to the face of the floor covering that will enter into contact with the surface to be covered.

13. The method according to claim 11, comprising a step of packaging the strips (8) of synthetic floor covering in the form of a roll.
